(19) United States
(12) Patent Application Publication
(10) Pub. No.: US 2010/0054899 A1
(43) Pub. Date: Mar. 4, 2010

(54) Storage Container Transport Device

(76) Inventor: William Shawn Hacker, American Canyon, CA (US)

Correspondence Address: Richard J. Steeno, 3114 Summer Grove Ct., Mansfield, TX, 76063, US

(21) Appl. No.: 12/200,090

(22) Filed: Aug. 28, 2008

(51) Int. Cl. B60P 1/02

(52) U.S. Cl. 414/470

(57) ABSTRACT

A device for the loading, transport and unloading of a storage container. A vehicle is provided having a cab and loading assembly supported by a flat bed portion of the vehicle. The loading assembly is characterized as having a trolley, selectively movable between a forward position proximate the cab and an aft position proximate the back of the flat bed portion. The trolley is moved by a drive assembly between the fore and aft positions and supports hydraulically actuated swing arms appended to the trolley for selectively engaging the storage container and for lifting and lowering the storage container onto and off of the flat bed portion and for moving the storage container toward the forward position for transport by the vehicle. The hydraulically actuated swing arms are adjustable to accommodate storage containers with varying widths.

### TECHNICAL FIELD

The present invention relates to and involves a device for lifting, transporting and unloading storage containers using a controlled orientation lifting mechanism and the flat bed portion of a moving vehicle. The present invention can accommodate storage containers of various widths creating flexibility unavailable by similar devices that currently exist.

### BACKGROUND OF THE INVENTION

The moving and storage industry has evolved to such an extent that storage containers have become an increasingly important adjunct to the industry. Historically, one wishing to move industrial or household goods would arrange for the pick up of such goods by a professional moving company. The moving company would drive a van to a designated pick up location whereupon the goods to be moved would be loaded, in real time, onto the van for ultimate transport to an intermediate storage area or final destination. This required scheduling between the moving company and owner of the goods to be transported resulting not only in inconvenience but oftentimes damage to the transported goods themselves.

A trend in the moving industry has now emerged. It has become more commonplace to respond to a request for moving industrial or household goods to deliver empty storage containers to an appropriate site allowing the owner of the goods to load the storage containers either themselves or with the aide of professional movers. Once loaded, the containers could then be moved to a final destination and unloaded at that point. The benefits in doing so are many in that the storage containers could remain at their debarkation points to enable them to be loaded slowly and carefully to not only minimize damage but also to enable the owner of the goods to segregate certain items either because of their breakable nature or to arrange an orderly thought out scheme of unloading for placement in their new location.

A system for transporting containers by a moving vehicle was disclosed in U.S. Publication No. 200710071586. The '586 publication discussed U.S. Pat. Nos. 6,071,062 and 6,155,770, each directed to a truck that can load and unload specifically configured containers at remote locations for transport. The author of the publication criticized the prior art alleging that the inventions of the '062 and '770 patents taught self-contained apparatus for lifting, handling, and transporting containers of a desired width, employing components that are cumbersome and complex. Furthermore, it was alleged that the prior art loading and unloading scheme was excessively time consuming and inefficient. The '586 publication taught a system that employs a trailer that is either connected to a truck or integral with a truck. The trailer is taught to be equipped with channels that allow a wheeled dolly to travel back and forth between front and rear ends of the trailer. The dolly was taught to be positioned at or near the front end during travel and at or near the rear end during lifting and lowering of the container. It was taught that the dolly was to be propelled forward and rearward of the trailer by a pair of hydraulic actuators that work in a complimentary manner. Alternatively, it was taught that the dolly could be moved relative to the truck and trailer with a wench cable system. The dolly was also taught to include lifting apparatus extending rearward. In one of the embodiments of the invention disclosed in the '586 publication, the lifting apparatus included yoke arms that rotate about an axis, driven by hydraulic actuators. Distal ends of the yoke arms were taught to include a cradle with removal lifting extension for lifting a container. The cradle was taught to be rotatable about its distal end so that the cradle could maintain a level orientation with respect to the ground despite that the yoke arms rotate with respect to the ground. By remaining level with the ground, it was taught that the cradle could lift and handle a container while maintaining the container in an upright orientation. ft was further taught that the hydraulic actuators could control rotation of the cradles. After the dolly lifted the container, the dolly could be moved back to the front of the trailer while lowering the container into the trailer. Although the inventors of the '586 patent firmly believe that an advance of the art was presented, there remained certain limitations which would severely limit the universal application of the system disclosed therein. These limitations include the fact that the hydraulic system employed to move the dolly back and forth between front and rear ends of the trailer, thus extending the length of the trailer, leak hydraulic fluid as the moving vehicle travels while carrying its anticipated load of storage containers. This would be particularly the case if the vehicle was to travel along an uneven or bumpy surface. A further limitation of the system disclosed in the '586 publication is that the yoke 5 arms employed to grab and lift the intended storage container is capable only of rotating along a single axis. Thus, the spacing between the yoke arms cannot be changed resulting in the inability of these arms to engage storage containers of varying widths. Stated differently, only a single sized storage container would be capable of engaging these yoke arms and any deviation from a fixed width would make the system disclosed in the '586 publication unusable. It is thus an object of the present invention to provide a device for the transport of a storage container while improving upon the limitations of the prior art. It is yet a further object of the present invention to provide a device for the transport of a storage container which is resistant to the leaking of hydraulic fluid during 15 transport and which is capable of engaging storage containers of varying widths. These and further objects will be more readily appreciated when considering the following disclosure and appended claims.

### SUMMARY OF THE INVENTION

A device for the transport of a storage container comprising a vehicle having a cab and loading assembly supported by a flat bed portion of said vehicle. The loading assembly has a trolley, selectively movable between a forward position proximate said cab and an aft position proximate the back of said flat bed portion. A drive assembly is provided for selectively moving said trolley between said forward and all positions. Hydraulically actuated swing arms are appended to said trolley for selectively engaging said storage container for lifting and lowering said storage container onto and off of said flat bed portion and for moving said storage container towards said forward position for transport by said vehicle wherein spacing between said hydraulic actuated swing arms is adjustable to accommodate storage containers of varying widths.

### BRIEF DESCRIPTION OF THE FIGURES

FIG. 1 is a perspective view of the device of the present invention at rest prior to engaging a suitable storage container.

FIG. 2 is a perspective view of the device of FIG. 1 with its trolley moved toward an aft location positioned to accept a suitable storage container.

FIG. 3 is a perspective view of the device of the present invention having engaged a suitable storage container for lifting said container onto a vehicle for transport.

FIG. 4 is a perspective view of the device of the present invention in which the 10 storage container has now been moved onto a vehicle for ultimate transport.

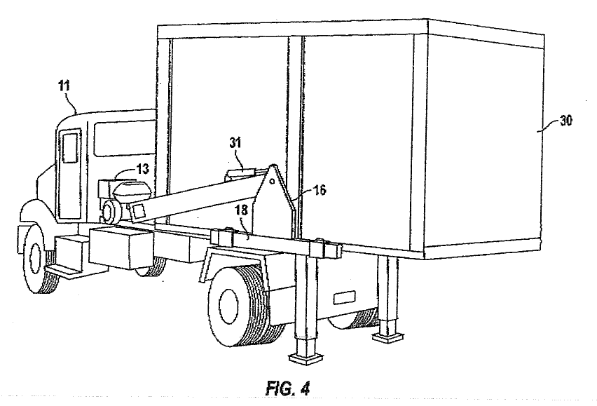

FIG. 5 is a perspective view of the drive mechanism for the trolley of the present invention.

FIG. 6 is a perspective view of the swing arm assembly of the present invention showing the details thereof.

### DETAILED DESCRIPTION OF THE INVENTION

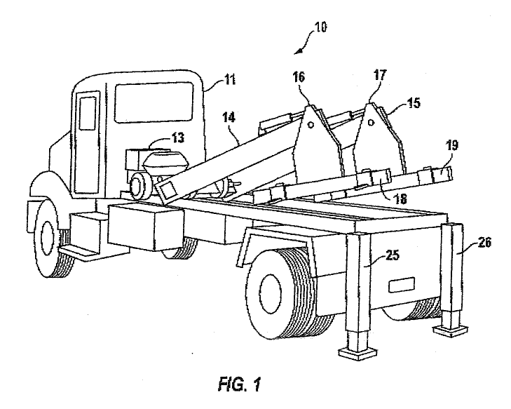

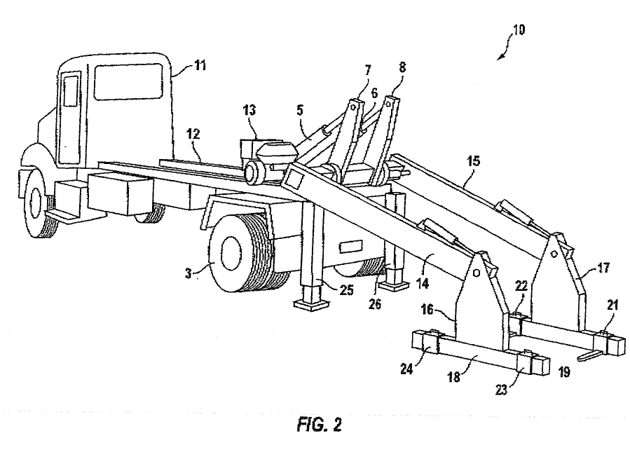

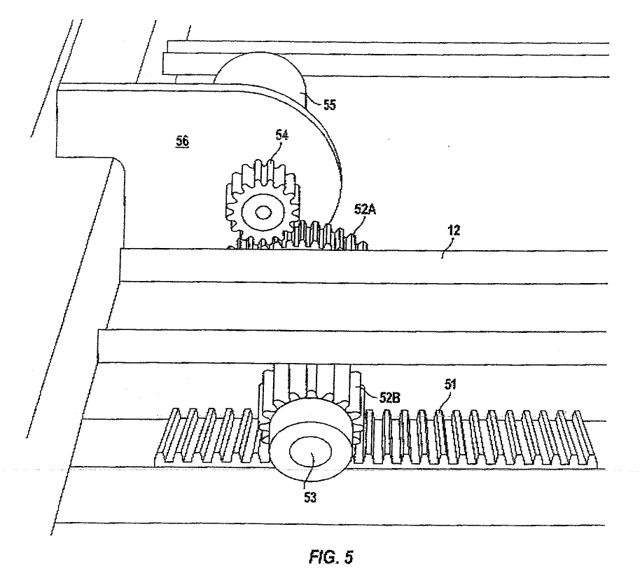

Tuning first to FIG. 1 & 2, device 10 of the present invention is depicted. Device 10 includes a vehicle having cab 11 and a loading assembly supported by flat bed 12 of the vehicle. As noted previously, it is an object of the present invention to provide a device capable of transporting a storage container from a first to second location This is first accomplished by backing the vehicle up proximate to a suitable storage container whereupon trolley 13 is caused to move from its forward position proximate cab 11 (FIG. 1) to a position proximate the aft end of the vehicle (FIG. 2). Unlike the prior art, movement of trolley 13 does not involve a longitudinally extending hydraulic ran (element 46 of '586 publication) for rains of this type tend to leak hydraulic fluid particularly when jostled along a bumpy roadway on a moving vehicle. Instead, movement of trolley 13 is carried out in a fashion illustrated in FIG. 5.

In turning to FIG. 5, it is noted that toothed rails 51 are situated along flat bed portion 12 of the vehicle. Shaft 53 passes from one side of the vehicle to the other such that toothed drive wheel 54 driven by motor assembly 55 rotates causing trolley support bracket 56 to move between forward and aft positions along flat bed portion 12. When the vehicle is moving empty or proceeding with a load (storage container 30), trolley 13 is located proximate cab 11 in a forward position on flat bed 12. However, when engaging a suitable storage container for lift and transport onto flat bed 12, trolley 13 extends to the aft position of flat bed 12 as depicted in FIG. 2. As the vehicle positions itself for engagement with storage container 30, engagement spikes 2 1-24 are repositioned from their outwardly extending orientation (Fig. I) to their inward orientation (FIG. 2). The vehicle is then backed towards storage container 30 and swing arms 14 and 15 rotated about shaft 65 by extending hydraulic actuators 5 and 6 thus rotating support arms 7 and 8 in order to position engagement spike support rails 18 and 19 proximate ground level. At this time, outriggers 25 and 26 can be extended in the event that container 30 contains a load heavy enough to tip the vehicle's cab 11 from its at rest position pivoting against rear wheels 3.

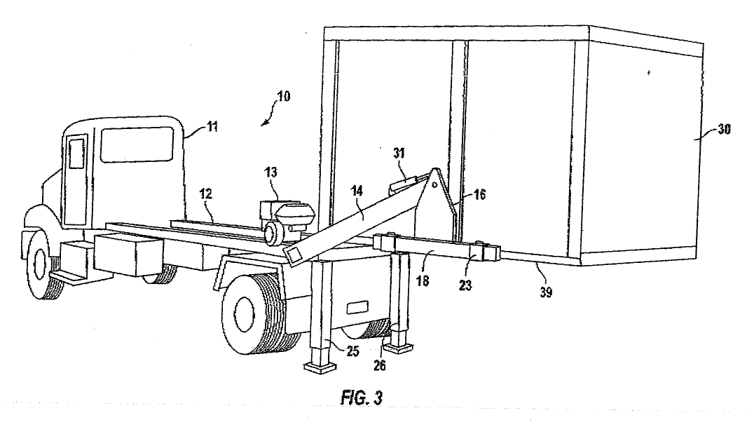

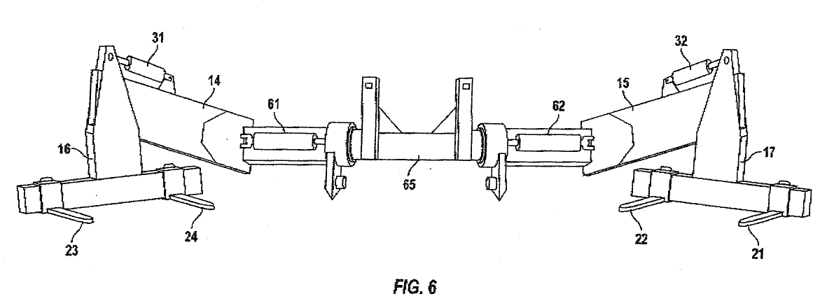

All standard storage containers 30 are configured with openings (not shown) proximate lower edge 39 for receipt of engagement spikes 21-24. An important aspect of the present invention is to provide the ability for altering the spacing between swing arms 14 and 15 in order to accommodate storage containers 30 of varying widths. In this regard, reference is made to FIG. 6 in which swing arm hydraulic actuator 61 and 62 are provided for this purpose. In proceeding with the engagement and lifting process) engagement spikes 2 1-24 engage complimentary openings along proximate bottom edge 39 of storage container 30 whereupon swing arms 14 and 15 move toward one another until engagement spikes 21-24 have fully engaged storage container 30. Thereupon, in reference to FIG. 3, swing arms 14 and 15 are caused to rotate about shaft 65 lifting storage container 30 from ground level to a height proximate flat bed portion 12. During this process, the horizontal orientation of container 30 can be properly maintained by stability hydraulic actuator 31 appended to support plates 16 and 17. Once the lifting function depicted in FIG. 3 has been accomplished, storage container 30 can then be moved along flat bed 12 from its aft position toward cab 11 of the vehicle by simply reversing the rotation of tooth drive wheel 54 causing trolley 13 and the appended swing arm assembly to move from the aft to forward positions. To maintain control over container 30, engagement spikes 2 1-24 can remain in place while swing arms 14 and 15 remain snugly against the sides of storage container 30 by controlling swing arm hydraulic actuator 61 and 62 and maintaining them in their gripping positions. Obviously, upon travel, outriggers 25 and 26 are withdrawn enabling the vehicle to transport its load (storage container 30) in a normal fashion. When unloading storage container 30; the procedure described above is simply repeated in reverse. Specifically, trolley 13 is moved from its cab forward position to its vehicle aft position by engaging motor 55 to turn toothed drive wheel 54 and thus toothed slave wheels 52A and 5Th along toothed rails 51.

Outriggers 25 and 26 are extended while container 30 is lifted from flat bed 12 and rearwardly of the vehicle. While maintaining the appropriate horizontal orientation through stability hydraulic actuator 31, swing arms 14 and 15 move from their orientation shown in FIG. 3 to that shown in FIG. 2. Thus, swing arms 14 and 15 rotate about axis 65 as a result of the forces imposed upon support arm 7 and 8 by hydraulic actuators 5 and 6. Once storage container 30 is in place, engagement spike support rails 18 and 19 are moved apart from one another as a result of the extension of swing ann hydraulic actuator 61 and 62 until engagement spikes 21-24 are completely removed from the corresponding openings in storage container 30 approximate lower edge 39. Engagement spikes 2 1-24 can then be repositioned outwardly on spike support rails 18 and 19 while swing anus 14 and 15 rotated to their at rest position as depicted in FIG. 1. Trolley 13 then returns to its cab 11 proximate location. The vehicle is then in a position to proceed while leaving storage container 30 in its delivered location. Although not constituting part of the present invention, it is noted that motor 55 can be hydraulically actuated. The additional hydraulic components as depicted above could be replaced with a suitable motor assemblies all of which could be controlled either at cab exterior locations or within cab 11 as convenience dictates, Regardless of its preferred embodiments, what is now depicted is a completely self contained) motorized device capable of engaging, lifting, transporting and disengaging storage containers of varying sizes and dimensions conveniently and simply while avoiding the limitations of the prior art. It is further understood that although the present invention has been depicted as a 20 motorized self contained device, it contemplates the use of an unmotorized assembly capable of linking to a motorized vehicle on demand in carrying out the functions as described above. Thus, those skilled in the art would be well cognizant of variations to the description of this invention as being equivalent thereto while not departing from the spirit and scope of the claimed invention.

What is claimed is:

1. A device for the transport of a storage container comprising a vehicle having a cab and loading assembly supported by a flat bed portion of the vehicle.

2. The device of claim 1 further comprising a loading assembly having a trolley, selectively movable between a forward position proximate the cab and an aft portion proximate the back of the flat bed portion.

3. The device of claim 1 further comprising a drive assembly for selectively moving the trolley between the forward and aft positions.

4. The device of claim 3 further comprising a motor and gear wheel which control and power the trolley between the forward and aft positions.

5. The device of claim 3 wherein the trolley is selectively moveable by providing a toothed gear rail along the flat bed portion extending from a position proximate the forward to a position proximate the aft locations and a mating toothed gear wheel, the rotation of which moves the trolley along the rail.

6. The device of claim 1 further comprising hydraulically actuated swing arms appended to the trolley for selectively engaging the storage container and for lifting and lowering the storage container onto and off of the flat bed portion and for holding the container in suspension while the storage container is moved forward and aft along the trailer bed.

7. The device of claim 6 further comprising hydraulically actuated swing arms which are adjustable to accommodate storage containers of varying widths.

8. The device of claim 6 wherein the hydraulically actuated swing arms are further capable of adjusting and maintaining a constant orientation of the storage container as it is raised onto and lowered from the flat bed portion of the vehicle.

9. The device of claim 6 further comprising protrusions on the swing arms to engage the container through openings on the lower side edges of the storage container.

10. The device of claim 1 wherein outriggers are positioned proximate the aft end of the flat bed engageable with the ground during loading and unloading of the storage container thereon to provide stability with heavier loads.
